(19) United States
(12) Patent Application Publication
(10) Pub. No.: US 2010/0232905 A1
(43) Pub. Date: Sep. 16, 2010

(54) JOINING STUD AND FASTENING ARRANGEMENT

(75) Inventors: Christian KEMPF, Würzburg (DE); Wolfgang LANGE, Lengerich (DE); Robert VOLNHALS, Ingolstadt (DE)

Correspondence Address: THE BLACK & DECKER CORPORATION, 701 EAST JOPPA ROAD, TW199, TOWSON, MD, 21286, US

(73) Assignee: NEWFREY LLC, Newark, DE (US)

(21) Appl. No.: 12/722,947

(22) Filed: Mar. 12, 2010

(30) Foreign Application Priority Data
Mar. 13, 2009 (DE) 10 2009 012 783.6

(51) Int. Cl. F16B 21/09; F16B 21/18

(52) U.S. Cl. 411/500; 411/516

(57) ABSTRACT

A double-T stud with ring flanges at each end, for joining onto a workpiece surface. The stud including a joining portion and a head portion located at opposite ends of a shank. The head and joining portions formed as identical annular flanges with diameters greater than the shank portion. The stud is axially symmetrically in relation to a plane extending transverse to the shank.

### CROSS-REFERENCE TO RELATED APPLICATIONS

This application claims priority from German Patent Application No. 10 2009 012 783.6, filed on Mar. 13, 2009, the disclosure of which is incorporated herein by reference.

### BACKGROUND OF THE INVENTION

The present invention relates to a stud according to the preamble of Claim 1, and to a fastening arrangement, comprising a workpiece, onto the surface of which a stud is joined, and comprising a clip, by means of which an object is fixed onto the workpiece.

In particular, the present invention relates to such a joining stud and to a fastening arrangement that are designed to fix a substantially flat object, such as an underbody facing, onto a workpiece, such as a motor-vehicle body portion. The work-piece may be, for example, a sheet-metal material or another thin material.

For the purpose of fastening objects to workpieces, there is known the practice of joining studs onto workpiece surfaces, in particular by welding or by adhesive-bonded joints. A clip, which is usually made of plastic, is fixed to such a stud. The clip serves to fix the object relative to the workpiece.

### BRIEF SUMMARY OF THE INVENTION

It is the object of the invention to specify an improved stud and an improved fastening arrangement for the above mentioned purposes.

The above object is achieved by a stud according to Claim 1 and by a fastening arrangement according to Claim 8.

The stud according to the invention has, on the one hand, a joining portion that is provided at one end of the shank portion and realized as an annular flange. Such annular-flange studs are known in principle. Such studs are suitable, in particular, for joining onto workpieces of a relatively small material thickness (for example, <1 mm or the like). A greater projected area can thereby be achieved, such that the joint can have a relatively high strength despite the small material thickness of the workpiece. Further, a head portion is provided at the other end of the shank portion. Owing to the head portion, which has a greater diameter than the shank portion, it is possible to fix clips onto the stud, in that these clips are not pressed onto the stud in axial direction but are pushed laterally onto the stud, the clip engaging the head portion axially. A fastening arrangement of low height can thereby be realized. Advantageously, the required mounting space above the stud is likewise smaller.

Consequently, in the case of the fastening arrangement according to the invention, a clip is pushed onto the head portion in a transverse direction relative to the shank portion, in order to fix the object onto the workpiece.

The object is thus achieved in full.

The head portion may be realized as a solid portion, but is preferably realized as an annular flange. The head portion can thus be similar in form to the flange portion, this providing advantages in the automatic supplying of the stud to a joining tool.

It is particularly preferred if the head portion has the same diameter as the joining portion. The stud can thus be supplied without difficulty to a joining tool, for example by means of pneumatic supply lines.

In particular, it is preferred if the stud is realized symmetrically in relation to a plane extending transversely relative to the shank portion.

It is particularly advantageous in this case that it is immaterial whether the stud is inserted into a joining tool with the head portion or the joining portion foremost, since the joining portion and the head portion are of identical design, and both are suitable as both joining portion and head portion.

Further, it is advantageous if the stud is realized as a single piece. The stud can thus be produced inexpensively.

The stud in this case can be made of metal or of plastic. In the case of the metal stud, the latter is preferably joined to a metal workpiece by welding (so-termed “stud welding”). In the case of a plastic stud, the latter can be adhesive-bonded onto a workpiece surface of any material. If the workpiece is likewise made of plastic, it is possible for the plastic stud to be joined to the workpiece by thermal welding.

In the case of the fastening arrangement according to the invention, it is advantageous if the clip has a clamping portion, which is clamped between the head portion and the joining portion of the stud. In the case of this variant, the clip is clamped onto the stud, not between the head portion and the workpiece, but between the head portion and the joining portion. The distance between the head portion and the joining portion can be realized with a significantly lesser tolerance (i.e., with greater dimensional exactness), such that particularly secure fixing of the clip to the stud is possible.

According to a further preferred embodiment, the object is fixed between a fastening portion of the clip and the surface of the workpiece.

In this case, the object is aligned, in particular, so as to bear flatly on the workpiece, and is held on the workpiece from above by means of the clip.

It is particularly preferred in this case if the fastening portion has at least one fastening arm, which extends radially outwards from the clamping portion.

As a result, the flat object can be fixed with a relatively large projected area, and therefore securely, onto the workpiece.

Further, it is advantageous in this case if at least two fastening arms are connected to one another at their distal ends to form a pressure portion.

In the case of this embodiment, the pressure area acting upon the object can be enlarged. The pressure portion in this case can extend substantially along a circular form that is aligned concentrically relative to the stud and that is at least twice the distance from a longitudinal axis of the stud than the diameter of the head portion.

Owing to the enlarged pressure area, a secure joint can be achieved, particularly in the case of elastically or plastically yielding materials of the object, without excessively high localized forces being exerted upon the object.

It is understood that the abovementioned features and those to be explained in the following can be applied, not only in the respectively specified combination, but also in other combinations or singly, without departure from the scope of the present invention.

### BRIEF DESCRIPTION OF THE SEVERAL VIEWS OF THE DRAWING

Exemplary embodiments of the invention are represented in the drawing and explained more fully in the following description, wherein:

FIG. 1 shows a longitudinal section through a first embodiment of a stud according to the invention;

FIG. 2 shows a perspective view of a fastening arrangement according to the invention, wherein a stud is joined onto a workpiece surface and an object (represented here, schematically, in the form of a circular disc, but usually extending over a greater area) is laid onto the workpiece surface; in this case, the object has a recess, through which the stud projects relative to the upper face of the object;

FIG. 3 shows the fastening arrangement of FIG. 2, a clip having been pushed laterally onto the stud, as a result of which the object is fixed onto the work-piece;

FIG. 4 shows a sectional view through the fastening arrangement of FIG. 3;

FIG. 5 shows an oblique top view of an alternative embodiment of a stud according to the invention; and

FIG. 6 shows an oblique bottom view of a representation of the stud of FIG. 5.

### DETAILED DESCRIPTION OF THE INVENTION

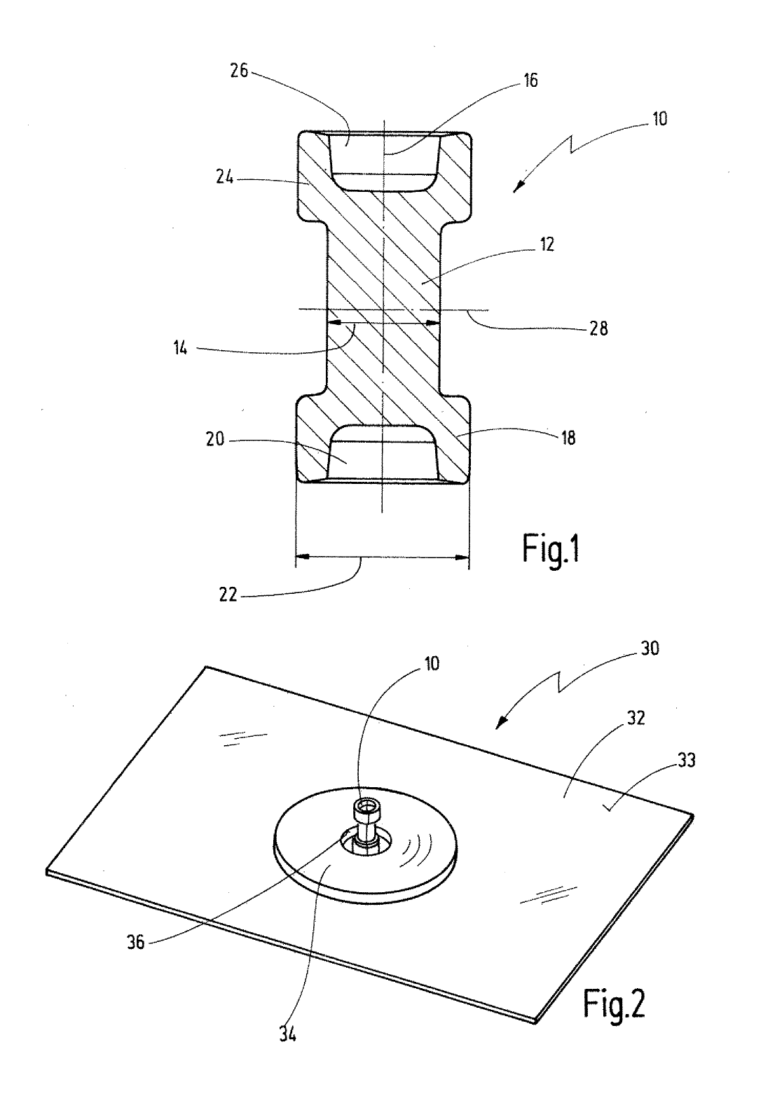

With reference to FIGS. 1-4, the stud 10 according to the invention has, on the one hand, a joining portion 18 that is provided at one end of the shank portion 12. Joining portion 18 is formed as an annular flange having a diameter 22 and defining a recess 20. Further, a head portion 24 is provided at the other end of the shank portion 12. Owing to the head portion 24, which has a greater diameter than the shank portion diameter 14, it is possible to fix a clip 40 onto the stud 10. Clip 40 is not pressed onto the stud 10 in the axial direction but, rather it is pushed laterally onto the stud, the clip engaging the head portion 24. A fastening arrangement of low height can thereby be realized. Advantageously, the required mounting space above the stud is likewise smaller.

Consequently, in the case of the fastening arrangement 30 according to the invention, a clip 40 is pushed onto the head portion 24 in a transverse (radial) direction 42 relative to the shank portion, in order to fix an object 34 onto the workpiece 32.

The head portion 24 may be realized as a solid portion, but is preferably realized as an annular flange with a recess 26. The head portion 24 can thus be similar in form to the joining portion 18, which symmetry is an advantage in the automatic supplying of the stud to a joining tool.

It is particularly preferred if the head portion 24 has the same diameter 22 as the joining portion 18. The stud 10 can thus be supplied without difficulty to a joining tool, for example by means of pneumatic supply lines.

In particular, it is preferred if the stud 10 is realized symmetrically in relation to a plane 28 extending transversely relative to the shank portion 12.

It is particularly advantageous in this case that it is immaterial whether the stud 10 is inserted into a joining tool with the head portion 24 or the joining portion 18 foremost, since the joining portion and the head portion are of identical design, and both are suitable as both joining portion and head portion.

Further, it is advantageous if the stud 10 is realized as a single piece. The stud can thus be produced inexpensively.

The stud 10 in this case can be made of metal or of plastic. In the case of the metal stud 10, the latter is preferably joined to a metal workpiece 32 by welding (so-termed “stud welding”). In the case of a plastic stud 10, the latter can be adhesive-bonded onto a workpiece surface 33 of any material. If the workpiece 32 is likewise made of plastic, it is possible for the plastic stud 10 to be joined to the work-piece by thermal welding.

FIG. 2 shows a perspective view of a fastening arrangement 30 according to the invention, wherein stud 10 is joined onto workpiece surface 33 and an object 34 (represented here, schematically, in the form of a circular disc 34, but usually extending over a greater area) is laid onto the workpiece surface 33. In this case, the object 34 has a recess 36, through which the stud 10 projects relative to the upper face of the object;

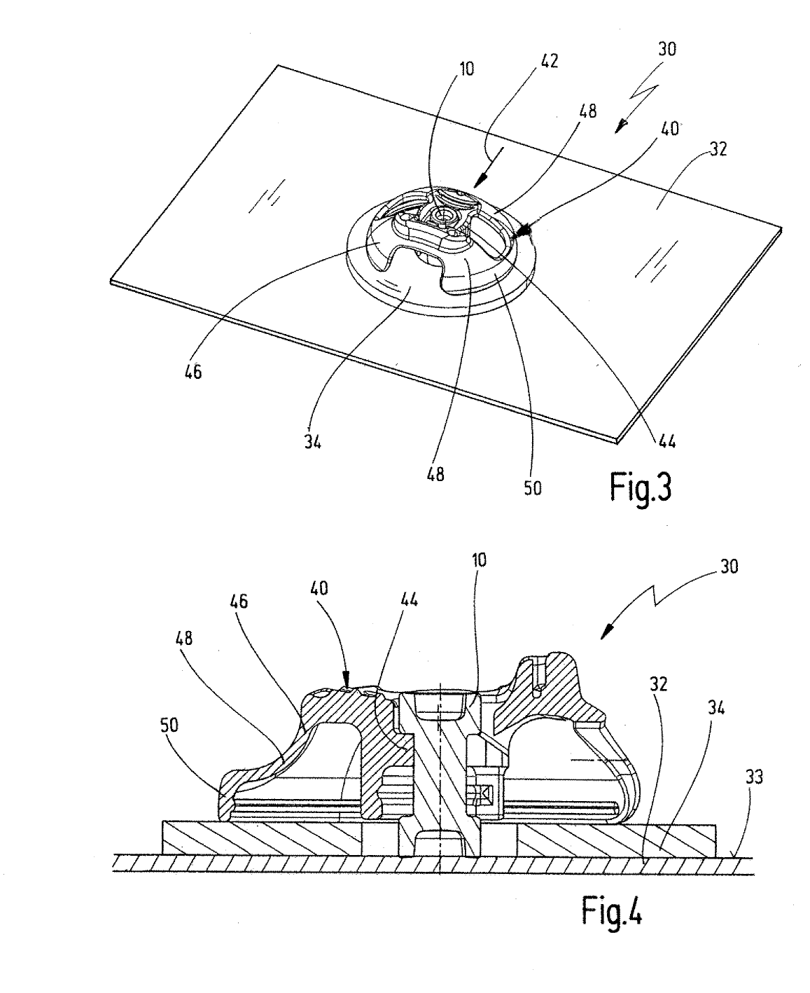

FIG. 3 shows the fastening arrangement of FIG. 2, with a clip 40 having been pushed laterally 42 onto the stud 10, as a result of which the object 34 is fixed onto the workpiece 32.

In the case of the fastening arrangement 30 according to the invention in FIGS. 3 and 4, it is advantageous if the clip 40 has a clamping portion 44, which is clamped between the head portion 24 and the joining portion 18 of the stud. In the case of this variant, the clip 40 is clamped onto the stud 10 between the head portion 24 and the joining portion 18, not between the head portion 24 and the workpiece 32. The distance between the head portion 24 and the joining portion 18 can be realized with greater dimensional exactness, such that particularly secure fixing of the clip 40 to the stud 10 is possible.

According to a further preferred embodiment, the object 34 is fixed between a fastening portion 46 of the clip 40 and the surface 33 of the workpiece 32.

In this case, the object 34 is aligned, in particular, so as to bear flatly on the workpiece 32, and is held on the workpiece 32 from above by means of the clip 40.

It is particularly preferred in this case if the fastening portion 46 has at least one fastening arm 48, which extends radially outwards from the clamping portion 44. As a result, the flat object 34 can be fixed with a relatively large projected area, and therefore securely, onto the workpiece 33.

Further, it is advantageous in this case if at least two fastening arms 48 are connected to one another at their distal ends to form a pressure portion 50. In the case of this embodiment, the pressure area acting upon the object 34 can be enlarged. The pressure portion in this case can extend substantially along a circular form that is aligned concentrically relative to the stud 10 and that is at least twice the distance from a longitudinal axis 16 of the stud than the diameter 22 of the head portion 24.

Owing to the enlarged pressure area, a secure joint can be achieved, particularly in the case of elastically or plastically yielding materials of the object, without excessively high localized forces being exerted upon the object.

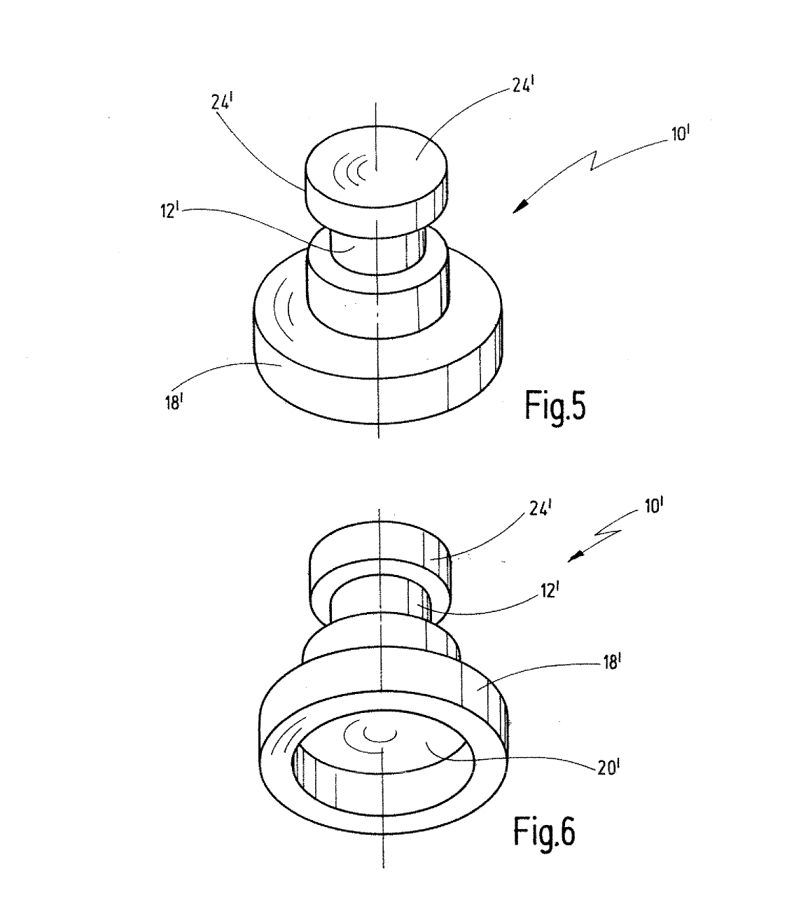

FIG. 5 shows an oblique top view of an alternative embodiment of a stud according to the invention; and FIG. 6 shows an oblique bottom view of a representation of the stud of FIG. 5. The stud 10′ of FIG. 5 differs from the stud 10 of FIG. 1 in the shape and geometry of its head portion 24′, shaft portion 12′ and joining portion 18′. The head portion 24′ might have the same diameter as the head portion 24 of the stud 10 of FIG. 1. However, the optional recess 26 of the stud 10 of FIG. 1 has been omitted. The shaft portion 12′ might substantially have the same diameter as the shaft portion 12, but presently includes an enlarged sub-portion having a greater diameter which might be required by a specific shape of a clip 40′ (not shown here). An axial length of the shaft portion 12′, including the sub-portion having the extended diameter, might be the same as for the shaft portion 12 of FIG. 1. The joining portion 18′ might have a greater diameter than the head portion 24′. The joining portion is following the shaft portion 12′ and also has a recess 20′, dimension of which is similarly chosen as for the recess 20 in FIG. 1.

It is understood that the abovementioned features and those to be explained in the following can be applied, not only in the respectively specified combination, but also in other combinations or singly, without departure from the scope of the present invention.

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A stud for joining onto a workpiece surface, the stud comprising:
a shank including a first end and a second end and having first diameter,
a joining portion provided at the first end of the shank and shaped substantially as an annular flange and defining a first recess, the joining portion having a second diameter greater than the first diameter of the shank, and
a head portion provided at the second end of the shank and having a third diameter greater than the first diameter of the shank portion.

2. A stud according to claim 1, wherein the head portion is shaped as an annular flange and defines a second recess.

3. A stud according to claim 2, wherein third diameter of the head portion is the same as the second diameter of the joining portion.

4. A stud according to claim 3, wherein the stud is symmetrically in relation to a plane extending transversely relative to the shank portion.

5. A stud according to claim 4, wherein the stud is formed as a single piece.

6. A stud according to claim 5, wherein the stud is made of metal.

7. A stud according to claim 5, wherein the stud is made of plastic.

8. A fastening arrangement for securing an object on a surface of a workpiece, the fastening arrangement comprising:
a stud joined to the surface of the workpiece, the stud including:
a shank including a first end and a second end and having first diameter,
a joining portion provided at the first end of the shank and shaped substantially as an annular flange and defining a first recess, the joining portion having a second diameter greater than the first diameter of the shank, and
a head portion provided at the second end of the shank and shaped substantially as an annular flange and defining a second recess, the head portion having a third diameter equal to the second diameter of the joining portion;
wherein the stud is symmetrically in relation to a plane extending transversely relative to the shank portion; and
a clip, pushable onto the head portion of the stud in a transverse direction relative to the shank portion and by means of which the object is clamped to workpiece.

9. A fastening arrangement according to claim 8, wherein the clip includes a clamping portion, which is clamped between the head portion and the joining portion of the stud.

10. A fastening arrangement according to claim 9, wherein the clip includes a fastening portion, and wherein the object is clamped between a fastening portion of the clip and the surface of the workpiece.

11. A fastening arrangement according to claim 10, wherein the fastening portion includes a plurality of fastening arms extending radially outwards from the clamping portion; and the plurality of fastening arms are connected to one another at their distal ends to form a pressure portion.
